(19) United States
(12) Patent Application Publication
(10) Pub. No.: US 2019/0126513 A1
(43) Pub. Date: May 2, 2019

(54) HEATSINK AND HEATPIPES

(71) Applicant: Thin Tanks Pty Ltd, St Marys (AU)

(72) Inventor: Peter Snelling, St Marys (AU)

(73) Assignee: Thin Tanks Pty Ltd, St Marys (AU)

(21) Appl. No.: 16/177,666

(22) Filed: Nov. 1, 2018

(30) Foreign Application Priority Data
Nov. 2, 2017 (AU) 2017904455

(51) Int. Cl. B29C 33/04; B29C 41/42; B29C 41/46; F28D 15/02; F28F 1/14

(52) U.S. Cl. CPC B29C 33/04; B29C 41/42; F28F 1/14; F28D 15/0233; F28D 15/0275; B29C 41/46

(57) ABSTRACT

A heat pipe, a rotation molding apparatus comprising a heat pipe, a rotational molding, and a method of molding comprising using a rotational molding apparatus, are provided.

### FIELD OF THE INVENTION

This application claims Paris priority to Australian provisional application 2017904455 naming applicant THIN TANKS PTY LTD, local attorney reference 67458 DIA:JP, filed 2 Nov. 2017. This application incorporates by reference the foregoing Australian provisional application 2017904455.

This invention relates primarily to the manufacture and configuration of water tanks, in particular to the production of rectangular thin tanks for domestic water storage using heat pipes within the mold to provide even and controlled heating and cooling of the mold.

### DESCRIPTION OF THE PRIOR ART

Rotational molding is cycling process where polyethylene or other appropriate materials are placed inside a rotational mold as a powder. The mold is then heated to the desired temperature, the powder melts and, due to the rotational movement of the mold, the melted polyethylene forms an even coat over the internal surface of the mold. The process is made up of essential four steps: mold charging, mold rotation, mold cooling and removing the product from the mold.

Molding thin tanks is a more difficult task, as it requires the structural inclusion of connections between the two vertical faces of the tank.

The incorporation and use of heat pipes in the rotational molding process has been shown to be a great improvement over earlier rotational molding methodologies which were not suitable for use in the production of non-circular tanks, as particular non-circular tanks having a thin wall construction.

We have recently shown that the incorporation of stiffening features called a “kiss-off”(kiss-off ribbing) into the mold for a thin tank has a greatly unexpected impact on the structure of the thin tank and opens up the roto-mold process in the production of the thin walled tanks.

This can be done by including large holes between the two vertical faces, sufficiently large enough so as to allow hot air to circulate across the surface of the mold connecting the two faces in order to achieve the desired surface temperatures of the mold that allows the even distribution of the melted polyethylene material.

In order to achieve this we had shown that by using a mold having a number of inwardly projecting hollow cylinders or cones, each inwardly projecting hollow cylinder having a fluid sealed within, the fluid being capable of absorbing heat from an external source so that on a heating of the rotational mold the fluid is heated to provide an even heating across an outer surface of the inwardly projecting hollow cylinders, which was a great improvement.

The heat pipe is a hermetically sealed evaporation and condensing system that functions to effect transfer of thermal energy in from one part of the system to another. Heat pipes typically include a sealed elongated container made of a heat conductive metal that is circumferentially secured to the interior surface of the mold or can be selectively inserted into appropriately sized openings or apertures in the mold.

However, there remains an issue with such a system of molding, primarily due to the large surface area of the mold and the different shapes of product, which involve different rates of heat transfer resulting in uneven wall thickness and acute angles between surfaces can at times, depending upon the shape of the product that is being molded, result in excessive cycling times of the rotomold apparatus as well as differences in surface finish and structure.

The typical cycle for a rotational molding process comprises the steps of charging the mold, (b) heating the mold, (c) cooling the mold and finally (d) de-molding. We have observed that the stage of cooling and de-molding which are problematic when rotational molding thin tanks as due to their size the require additional cooling time to ensure that the thin walls of the structure have adequately cooled to reduce or eliminate the likelihood that the product will be de-molded whilst the polyethylene material has not adequately cooled to the appropriate temperature. Failure to do so results in the thin plastic walls of the structure lacking the structural integrity to retain its desired shape and they begin to collapse or sag leading to deformation of the structure.

### OBJECT OF THE INVENTION

It is an object of the present invention to overcome, or at least substantially ameliorate, the disadvantages and shortcomings of the prior art.

Other objects and advantages of the present invention will become apparent from the following description, taking in connection with the accompanying drawings, wherein, by way of illustration and example, an embodiment of the present invention is disclosed.

### SUMMARY OF THE INVENTION

According to the present invention, although this should not be seen as limiting the invention in any way, there is provided a heat-pipe for a rotational molding apparatus, the heat-pipe being a hollow cylinder having a first end and a second end, the second end having a thermal energy absorbing/dissipating means located thereon.

In preference, the heat-pipe is a heat transfer pipe.

In preference, the heat transfer pipe is cable of bidirectional transfer of heat.

In preference, the thermal energy absorbing/dissipating means includes a plurality of fins.

In preference, the thermal energy absorbing/dissipating means is affixed or integrated with the heat-pipe.

In preference, the thermal energy absorbing/dissipating means is a plurality of radially extending fins.

In preference, the plurality of radially extending fins surrounds a central core body, the central core body shaped to nestingly receive the second end of the heat-pipe.

In preference the thermal energy absorbing/dissipating means is one piece/unitary construction with the heat-pipe.

In preference, the heat-pipe is an inwardly projecting hollow cylinder.

In preference, the heat pipe includes having a fluid sealed within, the fluid being capable of absorbing heat from an external source.

In preference, the inwardly projecting hollow cylinder is cone shaped.

In a further form of the invention there is a rotational mold having an inner surface and an outer surface, having a mold surface with a plurality of heat-pipes located thereon, each of the plurality of heat-pipes being capable of absorbing heat from an external source, the heat-pipe having a first end and a second end, the second end with thermal energy absorbing/dissipating means located thereon.

In preference, the plurality of inwardly projecting hollow cylinders are located on an inner front surface and an inner hack surface of the mold.

In preference, the plurality of inwardly projecting hollow cylinders are arranged in pairs.

In preference, the plurality of inwardly projecting hollow cylinders are arranged in pairs aligned with one another.

In preference, the inwardly projecting hollow cylinders hollow are cone shaped.

In preference, the fluid is water.

In preference, the mold is a rotational mold.

In preference, the tank is a fluid tank.

In preference, the water tank is a vertical water tank.

In preference, the vertical water tank is a slimline water tank or a thin water tank.

In preference, the vertical water tank is a rectangular water tank.

In preference, the inwardly projecting hollow cylinders are partially filed with a liquid.

In preference, the liquid is water.

In preference, the inwardly projecting hollow cylinders are sealed to create a sealed inner chamber.

A method of molding comprising using a rotational mold ng apparatus comprising a plurality of heat pipes of claim 1, the method comprising the steps of: inserting the plurality of heat pipes into a plurality of channels around an outer surface of a rotational mold; adding a plastic material into the rotational mold; applying heat to the outer surface of the rotational mold thus heating the plurality of heat pipes which transfer heat into the channels thus heating the internal surface of the rotational mold evenly; rotationally molding said plastic material in the rotational mold to form a plastic coating on the internal surface of the mold; and allowing said rotational mold to cool to allow said plastic material to solidify.

When the rotational mold is removed from the oven, the temperature of the mold must be reduced significantly so as to extract a solidified product and then reheated with a new load of polyethylene powder. During this cooling and reheating cycle, the inwardly projecting hollow cylinders or heat pipes remain at an elevated temperature with regards to the other internal surfaces of the mold. The heat pipes of the present invention help significantly in increasing the rate at which the heat within the mold is removed and can be used with or without any sealed evaporating—condensing fluid.

The kiss-off formed during the present invention are formed as an “almost” kiss-off where there is a slight gap between the two end walls of the heat pipes to accelerate the heat gain on the heat pipes to improve the rate of plastic material deposited on the heat pipes to improve the structural integrity and also shorten the production cycling time by accelerating the heat loss on the heat pipes. The gap between the two ends fills with polyethylene thereby sealing the inside snakes to make the tank water tight.

### BRIEF DESCRIPTION OF THE DRAWINGS

By way of example, an embodiment of the invention is described more hereinafter with reference to the accompanying drawings, in which:

FIG. 1 is a perspective view of an embodiment of a heat pipe of the present invention;

FIG. 2 is a perspective view of the heat pipe without the thermal energy absorbing/dissipating means attached;

FIG. 3 is a cross section view of the heat pipe from FIG. 1;

FIG. 4 is a perspective view of a mold showing a plurality of heat pipes in use;

FIG. 5 is a cross section view of the mold of FIG. 4;

FIG. 6 is a close up of section A from FIG. 5.

### DETAILED DESCRIPTION OF THE INVENTION

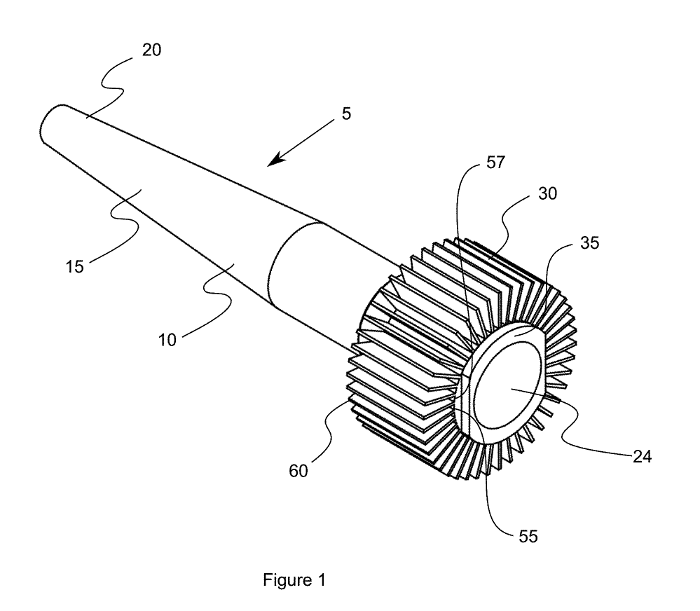

FIG. 1 shows a preferred embodiment of the present invention 5, having a main cylindrical body 10 with a conical section 15 tapering towards a closed first end 20. The closed-first end 20 is the end of the heat pipe 5 is inserted into a cavity on a surface of a rotational mold. Opposite to the closed first end 20 is the second end 30, about which there is a thermal energy absorbing/dissipating means 50. The second end 30 has a substantially uniform outer diameter with an outer surface 32, and an end flange 35.

The thermal energy absorbing/dissipating means 50 includes a circular main body 55 with an opening 57 shaped to allow the body 10 of the heat pipe 5 to be inserted into it and nestingly fit within. The heat pipe 5 can be press-fitted into the thermal energy absorbing/dissipating means so that there is a good surface—surface interaction between the thermal energy absorbing/dissipating means 50 and the condenser end 30, the flange 35 on the outer end of the second end 30 acting as a stop to prevent the thermal energy absorbing/dissipating means from passing over the second end 30. In other forms of the invention, the flange 35 may be alternatively located near the chamfer 37 so that the thermal energy absorbing/dissipating means 50 has to be attached from the second end 30.

Alternatively, the thermal energy absorbing/dissipating fins 50 are integral with the body 10 in that they are formed as a single component, the thermal energy absorbing/dissipating fins 50 being cast or molded with the body 10.

The plurality of radially extending fins 60 projects away from the circular main body 55, the circular main body 55 being ring shaped to allow the circular main body 55 with fins to be removed from the main cylindrical body 10 of the heat pipe 5, to provide a greatly increased surface area through which heat can be absorbed/dissipated. In this manner an operator may be able to select from a number of different thermal energy absorbing/dissipating fin components, some have larger fins or more fins than others, and also being made from differing materials as required. The thermal energy absorbing/dissipating means 50 and body 10 of the heat pipe 5 can be made of any suitable heat conductive material know to those skilled in the field.

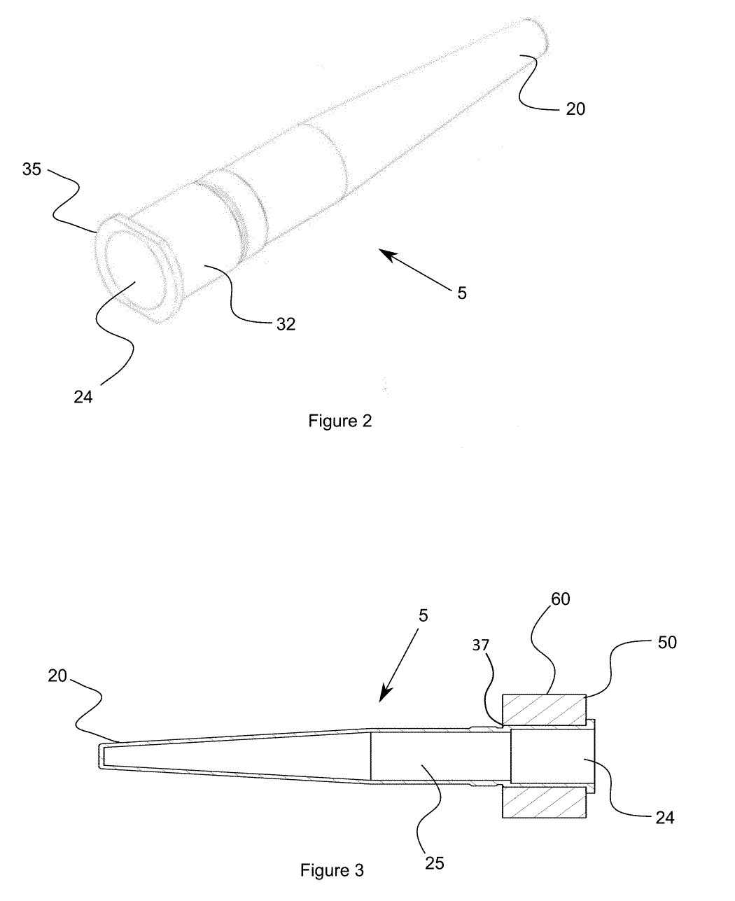

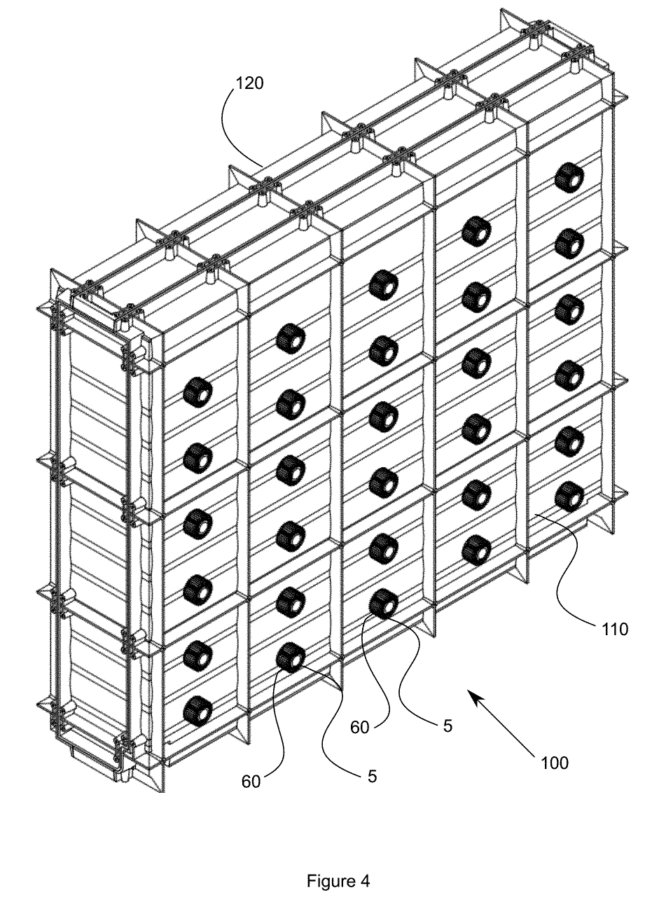

Referring to FIG. 2, the heat pipe 5 with the plurality of radially extending fins 60 removed to show the outer surface 32 of the second end 30. The heat pipe 5 is hollow with opening 24 and an internal cavity 25 as shown in FIG. 3, that has a first section of constant internal diameter that then tapers towards the first end 20. In some embodiments the cavity 25 is empty but in other embodiments the cavity 25 includes a fluid sealed within by either having a press fit cap or closure that seals the opening 24, the fluid being capable of absorbing heat by convection and evaporating to provide a vapour, the vapour then travelling towards either the first end or second end of the heat pipe, whichever end is cooler.

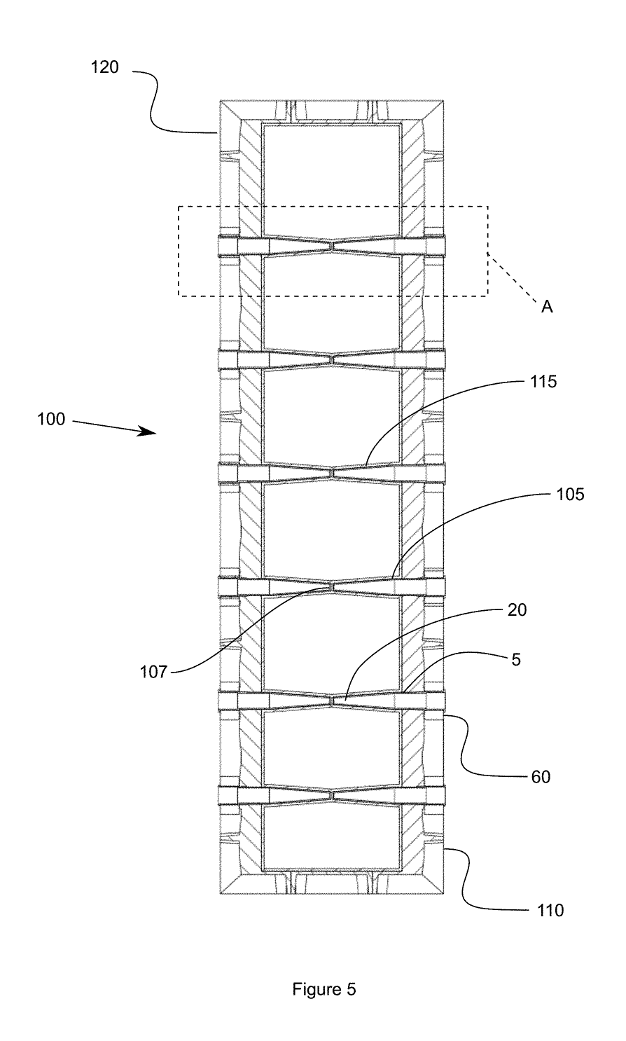

Referring to FIGS. 4 and 5, once assembled, the heat pipe 5 with the thermal energy absorbing/dissipating fins 50 can then be inserted into the appropriate sized cavities of the rotational mold 100 as shown in FIG. 4 in which there is a mold 100 for a water tank, the mold 100 having a first wall with a front outer surface 110 and a second wall with a rear outer surface 120, both of which have a plurality of channels 105a chamber is defined between the first wall and opposing second wall. The channels 105 are closed at an inside end 107, and the heat pipes 5 with cooling means 50 attached are inserted into an open end thereof.

In use, when the rotational mold charged with a plastic material enters the initial heating phase, heat is applied to the outside of the mold and the heat pipes 5 capture the latent heat on the outside of the mold, or applied to the outside of the mold, by way of the thermal energy absorbing/dissipating means 50, as well as allowing hot air to pass into the interior of the heat pipe 5, when the heat pipe is hollow thus allowing latent heat to pass through and along the heat pipe/heat transfer pipe from the second end 30 outside of the mold towards the first end 20. In this way the inwardly projecting cylinder/cone heat up quicker and more efficiently ensuring that the inwardly projecting cylinder/cone reaches the desired operating temperature in a shorter period of time than otherwise expected. This then results in an accelerated heating of the inside surface of the mold and importantly over the surface of the inwardly projecting cylinder/cone. When the rotational mold is rotated, the plastics material that has been added to it then begins to melt and thus can readily coat the surface of the inwardly projecting cylinder/cone and flow between the inwardly projecting cylinder/cones 5 without experiencing zones of less than optimal temperature on the inwardly projecting cylinder/cones 5 that may result in the plastic material on the surface of the inwardly projecting cylinder/cones 5 being too thin or too thick that may then adversely effect the strength or integrity of the kiss-off joint. The inner surface of the rotational mold is thus more evenly heated at this stage allowing for more uniform layering of melted plastic material both around and between the inwardly projecting cylinder/cones 5 of the rotational mold.

As the rotational mold enters the cooling phase, and the source of heat used to heat the mold is removed, the internal structure formed lacks structural integrity, particularly in the process of forming thin wall structures, as the plastics material is still hot and not yet solidified to allow demolding to provide the desired molded article. The presence of the heat pipes 5 with cooling means 50 results in a decrease in the cooling time to allow safe &molding in particular where the molded item includes a number of internal kiss-off ribbing structures such as thin walled plastic water tanks, where the kiss-off interconnects the two lateral sides of the tank to increases the strength of the tank body and also prevent the sides from bulging due to hydraulic pressure of the liquid inside the tank.

Heat in the mold 100 is transferred to the heat pipe 5 by conduction through the wall of the mold 100 and into the closed first end 20 of the heat pipe 5. The absorbed heat then travels along the main body 10 of the heat up and out of the mold 100 towards the second end 30, which in this situation is the heat dissipating end, and out through the thermal energy absorbing/dissipating fins 60. If desired a heat-exchange liquid can be sealed inside the cavity 25 to greatly increase the rate of heating/cooling by the liquid evaporating at the heat absorbing/dissipating end 20 and condensing at the second end 30.

Moreover, during the initial heating part of the production cycle, heat applied to the outside of the mold can be readily taken up by the fins 30 of the thermal energy absorbing/dissipating means 50, again due to their large overall surface are and suitable heat-transferring properties in the material. The absorbed heat is then quickly taken to the opposite end 20 and the cone section 115 of the mold then heats up faster compared to the other areas of the mold. Polyethylene material (solid) within the mold then softens and melts firstly at or close to the cone sections as the mold is rotated, ensuring then that polyethylene, or other suitable plastics material, is firstly deposited about or close to the cone sections, which is important as it is the cone sections and kiss-offs in the mold that provide greatly increased structural rigidity in the final product as well as ensuring reproducibility in production.

This results in greatly decreased heating and cooling times thus helping to decrease the overall cycling time of the mold, which increases the number of items that can be molded in a given time frame.

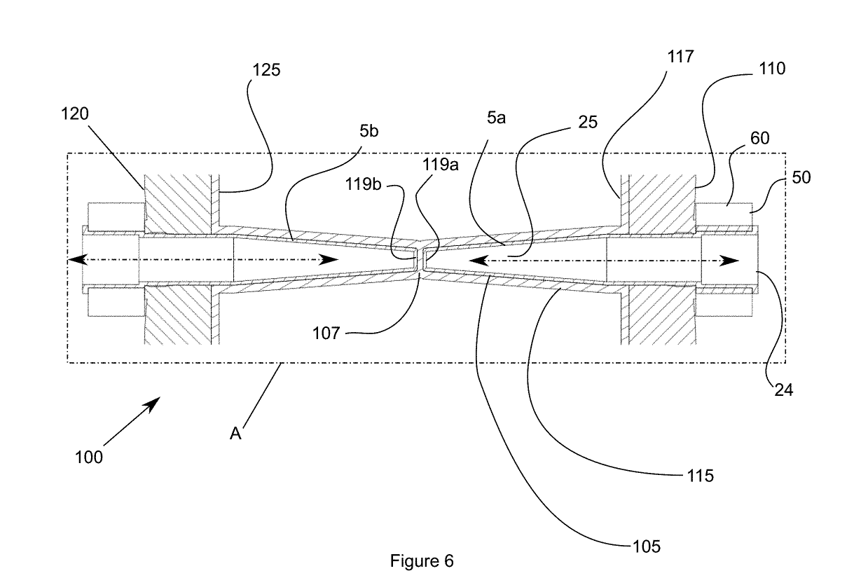

The heat transfer projections 5 are arranged in a grid pattern so that those on the inner surface 117 of the front wall 110 are substantially mutually aligned with the heat transfer projections 5 on the inner surface 125 of the back wall 120. As shown in FIG. 6, which is a close up view of a section of the rotational mold 110, the inwardly facing heat transfer projections 5a and 5b extend outwardly from the respective inner walls of the first wall and second wall but do not contact one another. The ends 119a and 119b of the heat transfer projections 5a and 5b are adjacent one another leaving a small gap between them. This then allows fluid plastic material to flow between the ends 119a and 119b to allow the formation of the support portion kiss-off in the water tank.

The heat transfer pipes as disclosed provide a new way to ensure quick and efficient transfer of latent heat from the outside of the mold to the inside of the mold during the initial heating phase when the mold is placed inside a heating oven, the heat energy being transferred firstly to the cone sections of the mold so as to ensure that the interior of the cone sections of the mold are properly covered with melted polyethylene. During the cooling cycle of production, the heat transfer pipes as disclosed provide quick and efficient transfer of latent heat from the inside of the mold to the outside of the mold to allow the cone section to cool down preferentially.

In this manner, the heat pipes of the present invention provide a manes of bidirectional heat transfer.

This ensures that the support portions, kiss offs, are formed in the strongest manner so that the structural integrity of the front and back wall of the tank is in no way compromised. This contrasts those tanks or containers of the prior art that have internal support structures that consist of either inwardly projecting indentations that abut one another or by employing standard known kiss-offs that result in the formation of blemishing of a surface of the tank or container. In addition, the heat transfer projections as described may be readily incorporated into any mold as required by those skilled in the filed, without the need for expensive time consuming mold construction that required water channels throughout the mold.

Although the invention has been herein shown and described in what is conceived to be the most practical and preferred embodiment, it is recognized that departures can be made within the scope of the invention, which is not to be limited to the details described herein but it is to be accorded the full scope of the appended claims so as to embrace any and all equivalent devices and apparatus.

1. A heat-pipe for a rotational molding apparatus, the heat-pipe comprising a body, the body being a hollow cylinder having a closed first end and a second end, the second end having a plurality of radially extending thermal energy absorbing/dissipating fins located thereon.

2. The heat-pipe of claim 1, wherein the plurality of radially extending thermal energy absorbing/dissipating fins slidingly engages with body of the heat-pipe.

3. The heat-pipe of claim 1, wherein, the plurality of radially extending thermal energy absorbing/dissipating fins surrounds a central core body, the central core body shaped to nestingly receive the second end of the heat-pipe.

4. The heat-pipe of claim 1, wherein the heat pipe includes having a fluid sealed within, the fluid being capable of absorbing heat.

5. The heat-pipe of claim 1, wherein the body of the hollow cylinder is cone shaped.

6. A rotational molding apparatus comprising a plurality of heat-pipes of claim 1.

7. A method of molding comprising using a rotational molding apparatus comprising a plurality of heat pipes of claim 1, the method comprising the steps of:
inserting the plurality of heat pipes into a plurality of channels around an outer surface of a rotational mold;
adding a plastic material to the rotational mold;
applying heat to the outer surface of the rotational mold thus heating the plurality of heat pipes which transfer heat into the channels thus heating the internal surface of the rotational mold evenly;
rotationally molding said plastic material in the rotational mold to form a plastic coating on the internal surface of the mold;
allowing said rotational mold to cool to alto said plastic material o solidify and produce a molded article; and
removing said article from said rotational mold.

8. A rotational mold for a water tank comprising a first wall and a second wall, said second wall opposing said first wall, said first wall and said second wall comprising a plurality of inwardly projecting cones, each inwardly projecting cone having inserted therein a heat pipe of claim 1.
